(19) United States
(12) Patent Application Publication
(10) Pub. No.: US 2012/0127527 A1
(43) Pub. Date: May 24, 2012

(54) Image Forming Apparatus, Information Setting System, And Information Setting Method

(75) Inventors: Kei Nakabayashi, Kanagawa (JP); Osamu Kizaki, Saitama (JP); Sachiko Takeuchi, Tokyo (JP); Takashi Nakamura, Kanagawa (JP); Hiroki Uchibori, Kanagawa (JP)

(73) Assignee: RICOH COMPANY, LTD., Tokyo (JP)

(21) Appl. No.: 13/300,865

(22) Filed: Nov. 21, 2011

(30) Foreign Application Priority Data
Nov. 22, 2010 (JP) 2010-260121

(51) Int. Cl. G06F 3/12

(52) U.S. Cl. 358/1.15

(57) ABSTRACT

In an image forming apparatus, setting information is stored in a storage part for a function which the image forming apparatus operates based on the setting information. An acquisition request of common setting information is sent to an information processing apparatus including the common setting information in common with multiple of the image forming apparatuses connected through a network. The common setting information is received from the information processing apparatus. It is monitored whether there is a job in the function. Timing for setting the common setting information, which is received by the receiving part to the setting information stored in the storage part, is controlled based on whether a non-processed job is prioritized or an update is prioritized.

### BACKGROUND OF THE INVENTION

1. Field of the Invention

The present invention generally relates to an image forming apparatus, an image setting system, and an image setting method, in which setting information is updated.

2. Description of the Related Art

Recently, since the number of functions included in an image forming apparatus has increased, the number of setting items has increased to operate the functions. Therefore, device settings have become more complex to install a new function and to update applications in the image forming apparatus, and workload of an administrator has been increased.

To solve the above described problem, a technology in which a setting operation is not required for each of image forming apparatuses has been proposed. For example, Japanese Laid-open Patent Application No. 2008-72318 discloses a technology in which the server retains setting information for each of the image forming apparatuses, each of the image forming apparatuses acquires the setting information corresponding to devices thereof, and the acquired setting information is registered.

However, in the above described technologies, since the setting information is retained for each of the devices, the workload of the administrator to administer the setting information is increased when the number of the devices is increased. In a case in which settings are collectively conducted for the entirety of devices connected to a network, the setting information for each of the devices is required to be the same information. Thus, greater workload is generated for the administrator to perform settings for each of the devices for each of the image forming apparatuses.

On the other hand, in the case in which settings are collectively conducted for the entirety of devices, a push-type setting method using a WebService/MIB may be considered to send and set the setting information for the image forming apparatuses. In a case of the push-type setting method, disadvantageously, if there are a large number of devices to be set, it takes time to apply the setting information. If one of the image forming apparatuses is not powered on, the settings are not collectively conducted.

### SUMMARY OF THE INVENTION

The present invention solves or reduces one or more of the above problems.

In one aspect of this disclosure, there is provided an image forming apparatus, including a storage part configured to store setting information for a function which the image forming apparatus operates based on the setting information; a sending part configured to send an acquisition request of common setting information to an information processing apparatus including the common setting information in common with multiple of the image forming apparatuses connected through a network; a receiving part configured to receive the common setting information from the information processing apparatus; a monitoring part configured to monitor whether there is a job in the function; and an update control part configured to control timing for setting the common setting information received by the receiving part to the setting information stored in the storage part based on whether a non-processed job is prioritized or an update is prioritized.

In another aspect of this disclosure, there is provided an information setting system, including multiple image forming apparatuses each of which operates based on setting information for a function stored in a first storage part; and an information processing apparatus connected to the multiple image forming apparatuses through a network, wherein the information processing apparatus includes a second storage part configured to store common setting information in common with the multiple image forming apparatuses connected through the network; and a communication part configured to send the common setting information to the multiple image forming apparatuses, when receiving an acquisition request of the common setting information from the multiple image forming apparatuses, and each of the multiple image forming apparatuses includes a sending part configured to send an acquisition request of the common setting information to the information processing apparatus; a receiving part configured to receive the common setting information from the information processing apparatus; a monitoring part configured to monitor whether there is a job in the function; and an update control part configured to control timing for setting the common setting information received from the receiving part to the setting information stored in the first storage part based on whether the non-processed job is prioritized or the update is prioritized.

In another aspect of this disclosure, there is provided an information setting method performed in an image forming apparatus which operates based on setting information for a function stored in a storage part, said information setting method comprising: a sending an acquisition request of common setting information to an information processing apparatus including the common setting information in common with multiple of the image forming apparatuses connected through a network; a receiving the common setting information from the information processing apparatus; a monitoring whether there is a job in the function; and controlling timing for setting the common setting information received by the receiving part to the setting information stored in the storage part based on whether a non-processed job is prioritized or an update is prioritized.

### BRIEF DESCRIPTION OF THE DRAWINGS

In the following, embodiments of the present invention will be described with reference to the accompanying drawings.

FIG. 1 is a diagram illustrating an example of an information setting system in an embodiment;

FIG. 2 is a schematic block diagram illustrating an example of a hardware configuration of an image forming apparatus in FIG. 1 in the embodiment;

FIG. 3 is a block diagram illustrating an example of hardware of an information processing apparatus in the embodiment;

FIG. 4 is a block diagram illustrating an example of a configuration of the image forming apparatus in the embodiment;

FIG. 5 is a diagram illustrating an example of a priority mode selection screen in the embodiment;

FIG. 6 is a block diagram illustrating an example of a configuration of the information processing apparatus in the embodiment;

FIG. 7A and FIG. 7B are diagrams illustrating an example of preference information in the embodiment;

FIG. 8 is a sequence diagram illustrating an example of a setting process of the preference information in the embodiment;

FIG. 9 is a sequence diagram illustrating an example of the setting process of the preference information for a job priority mode in the embodiment;

FIG. 10 is a sequence diagram illustrating an example of the setting process of the preference information for an update priority mode in the embodiment;

FIG. 11A and FIG. 11B are sequence diagrams illustrating a first example of the setting process of the preference information with an update confirmation in the embodiment;

FIG. 12 is a diagram illustrating a first example of the confirmation screen in the embodiment;

FIG. 13A and FIG. 13B are sequence diagrams illustrating a second example of the setting process of the preference information with the update confirmation in the embodiment;

FIG. 14 is a diagram illustrating a second example of the confirmation screen in the embodiment;

FIG. 15 is a sequence diagram illustrating an example of the setting process of the preference information performed for each of jobs in the embodiment;

FIG. 16A and FIG. 16B are sequence diagrams illustrating a first example of a setting error process in the embodiment;

FIG. 17 is diagram illustrating a first example of the setting failure notice screen in the embodiment;

FIG. 18A and FIG. 18B are sequence diagrams illustrating a second example of the setting error process in the embodiment;

FIG. 19 is a diagram illustrating a second example of the failure notice screen in the embodiment;

FIG. 20 is a sequence diagram illustrating a third example of the setting error process in the embodiment; and

FIG. 21 is a diagram illustrating a third example of the failure notice screen in the embodiment.

### DESCRIPTION OF THE PREFERRED EMBODIMENT

In the following, an embodiment of the present invention will be described with reference to the accompanying drawings.

### <System>

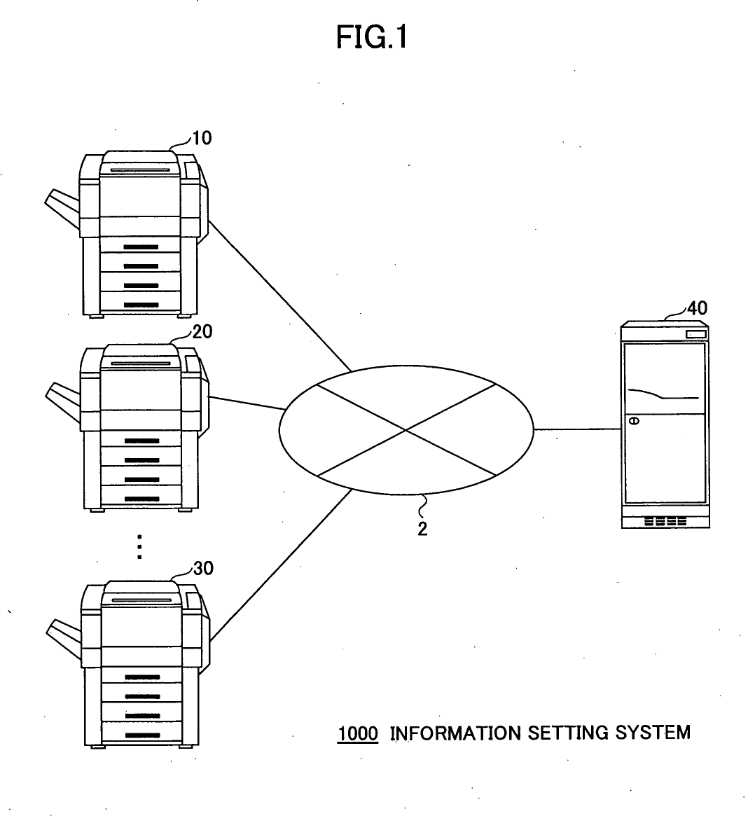

FIG. 1 is a diagram illustrating an example of an information setting system. In an information setting system 1000 illustrated in FIG. 1, image forming apparatuses 10, 20, 30, and the like are connected to an information processing apparatus 40 regarded as a server through a network 2. Each of the image forming apparatuses 10, 20, 30, and the like performs data communication with the information processing apparatus 40 through the network 2. The image forming apparatus may be an MFP (Multifunction Peripheral).

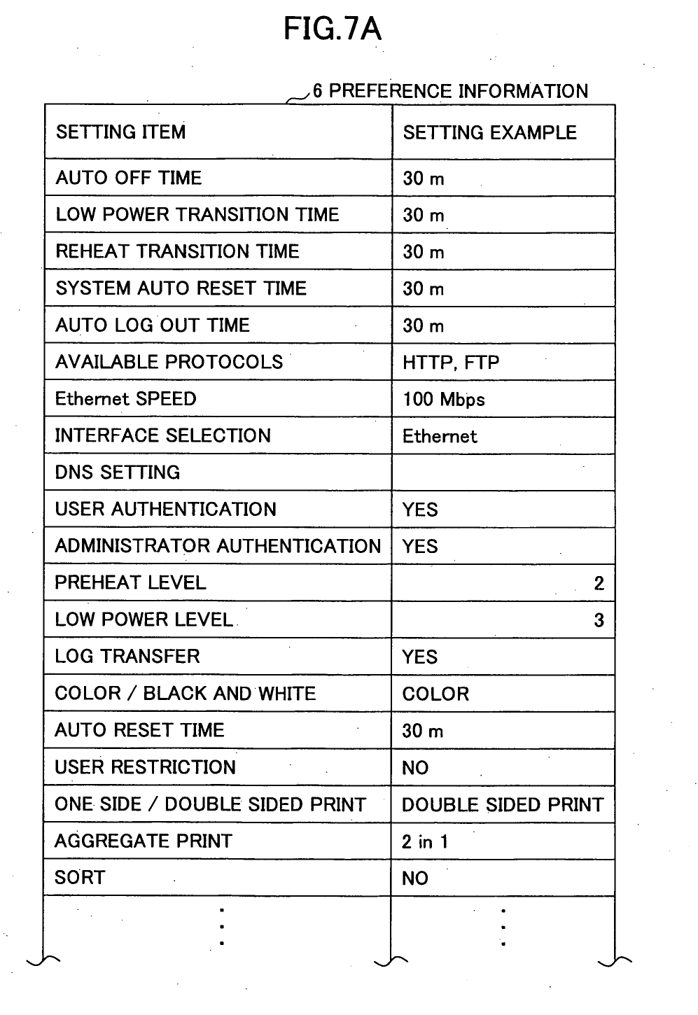

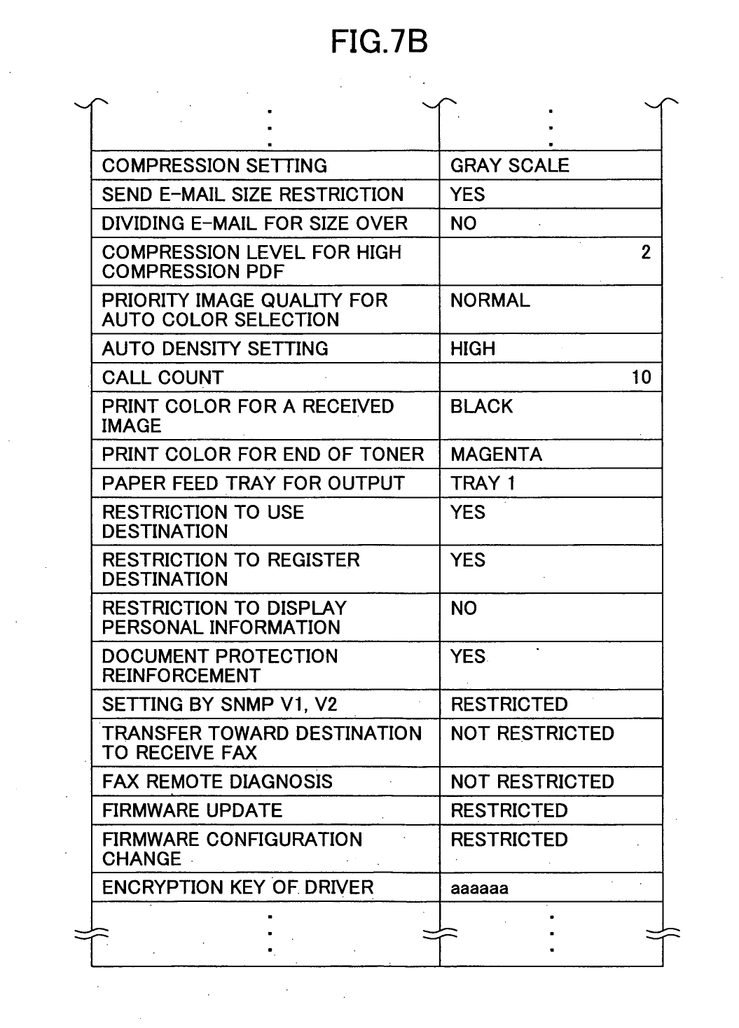

The image forming apparatus 10 may include a scan function, a copy function, a printer function, a facsimile function, and the like in a housing. The image forming apparatus 10 sends an acquisition request of setting information for each of functions (applications) to the information processing apparatus 40 through the network 2. The setting information may be regarded as common setting information and is called preference information (referred later as preference information 6 in FIG. 7A and FIG. 7B). The image forming apparatus 10 conducts a device setting by using the preference information acquired from the information processing apparatus 40. Since the image forming apparatus 10 is similarly configured to the image forming apparatuses 20 and 30, the image forming apparatus 10 may be represented in the following.

The information processing apparatus 40 retains the preference information which is set in common for all image forming apparatuses 10, 20, 30, and the like connected through the network 2. When receiving the acquisition request of the preference information from the image forming apparatuses 10, 20, 30, and the like, the information processing apparatus 40 sends the preference information to the image forming apparatuses 10, 20, 30, and the like.

That is, in the embodiment, a PULL type setting method is provided in a case in which the preference information in common for the image forming apparatuses 10, 20, 30, and the like is set.

### <Hardware>

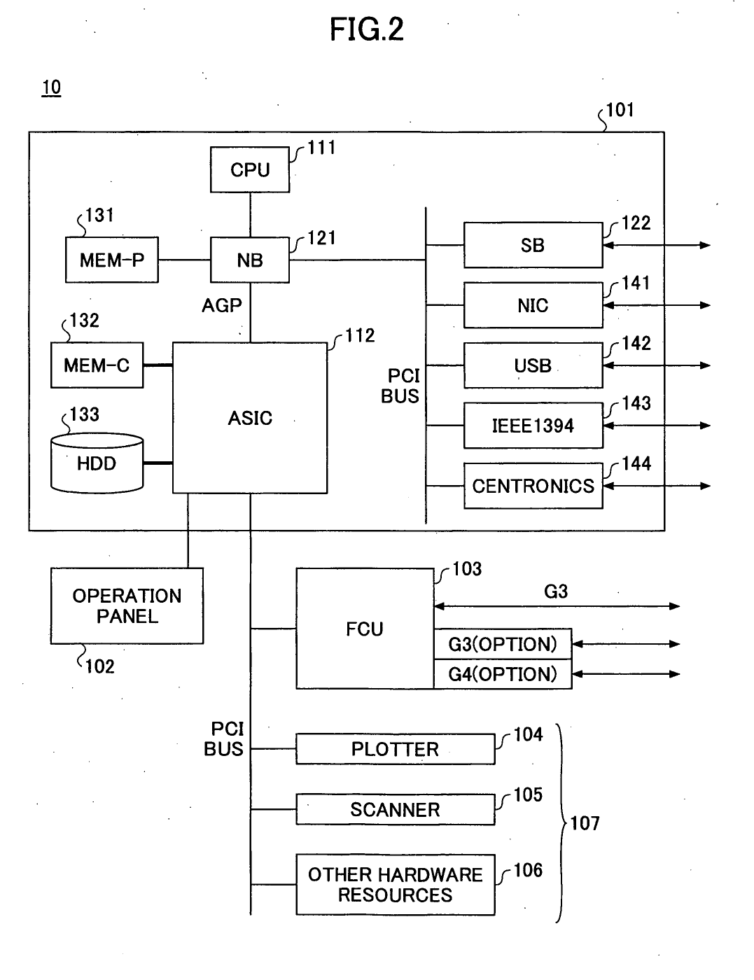

FIG. 2 is a schematic block diagram illustrating an example of a hardware configuration of the image forming apparatus 10 in FIG. 1. As hardware components, the image forming apparatus 10 includes a controller 101, an operation panel 102, a facsimile control unit (FCU) 103, an engine part 107, and the like. The engine part 107 includes a plotter 104, a scanner 105, other hardware resources 106, and the like.

The controller 101 includes a processor as a CPU (Central Processing Unit) 111, an ASIC (Application Specified IC) 112, an NB (North Bridge) 121, an SB (South Bridge) 122, an MEM-P 131, an MEM-C 132, an HDD (Hard Disk Drive) 133, an NIC (Network Interface Controller) 141, a USB (Universal Serial Bus) device 142, an IEEE 1394 device 143, a centronics device 144, and the like.

The CPU 111 is regarded as an IC (Integrated Circuit) for various information processes. The ASIC 112 is regarded as an IC for various image processes. The NB 121 is regarded as a north bridge of the controller 101. The SB 122 is regarded as a south bridge of the controller 101. The MEM-P 131 is used as a system memory of the image forming apparatus 10. The MEM-C 132 is used as a local memory of the image forming apparatus 10. The HDD 133 is used as an auxiliary storage device of the image forming apparatus 10.

The NIC 141 is regarded as a controller for a network communication using an MAC (Media Access Control) address. The USB device 142 is regarded as a device which provides a connection terminal of a USB standard. The IEEE 1394 device 143 is regarded as a device which provides a connection terminal of an IEEE 1394 standard. The Centronics device 144 is regarded as a device which provides a connection terminal of a Centronics specification.

The operation panel 102 is regarded as hardware (operation part) for an operator to input information to the image forming apparatus 10, and is also regarded as hardware (display part) for the operator to acquire an output of the image forming apparatus 10.

The FCU 103 sends and receives facsimile data in accordance with a regular G3 standard, and stores facsimile data which are received. The FCU 103 may further support the G3 standard and a G4 standard as options. The plotter 104 executes a print process. The scanner 105 reads out an original and generates document data.

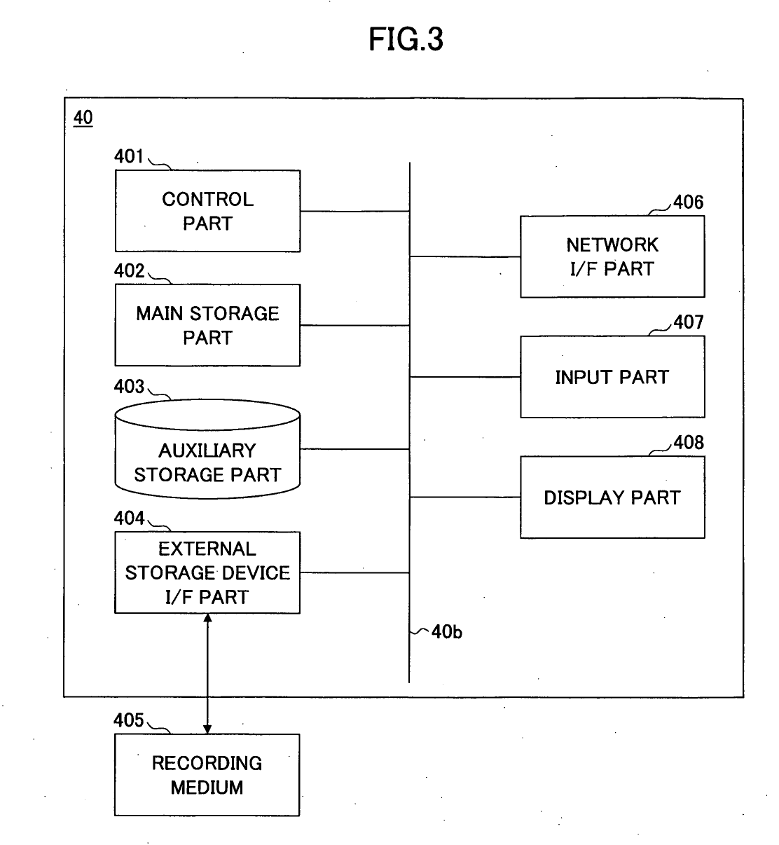

FIG. 3 is a block diagram illustrating an example of hardware of the information processing apparatus 40 in the embodiment. As illustrated in FIG. 3, the information processing apparatus 40 includes a control part 401, a main storage part 402, an auxiliary storage part 403, an external storage device I/F part 404, a network I/F part 406, an input part 407, and a display part 408 as component parts. These component parts 401 through 408 are connected via a bus 40b to be capable of mutually sending and receiving data.

The control part 401 is regarded as a CPU which controls each of the component parts 402 through 404 and 406 through 408, and performs calculations and processes for data in a computer. Also, the control part 401 is regarded as a processor which executes a program stored in the main storage part 402, receives data from an input device and a storage device, calculates for the data, processes the data, and then, outputs to an output device or a storage device.

The main storage part 402 corresponds to the storage device such as a ROM (Read Only Memory), a RAM (Random Access Memory), or the like which stores programs such as an OS (Operating System) regarded as basic software, application software, and the like which are executed by the control part 401, and temporarily retains data.

The auxiliary storage part 403 corresponds to the HDD (Hard Disk Drive) and is regarded as another storage device which stores data related to the application software or the like.

The external storage device I/F part 404 is regarded as an interface between a recording medium 405 and the information processing apparatus 40. The recording medium 405 may be realized by a non-transitory (or tangible) computer-readable medium such as a flash memory, an SD (Secure Digital) memory card, or the like connected through a data transmission channel such as a USB (Universal Serial Bus).

Also, a program is stored in the recording medium 405. The program stored in the recording medium 405 is installed to the information processing apparatus 40 via the external storage device I/F part 404. After the program is installed, the program is executed by the information processing apparatus 40.

The network I/F part 406 is used as an interface between the information processing apparatus 40 and peripheral devices having a communication function, which are connected through the network 2 such as a LAN (Local Area Network), a WAN (Wide Area Network), or the like which is configured by data channels such as wired or wireless communications.

The input part 407 includes a keyboard including a cursor key, numeral keys, various function keys, and the like, a mouse or a touch pad used to select a key on a display screen of the display part 408, and the like. Also, the input part 407 is regarded as a user interface for a user to instruct the control part 401 to perform an operation and input data.

The display part 408 may be realized by a CRT (Cathode Ray Tube), an LCD (Liquid Crystal Display), or the like, and displays based on display data input from the control part 401. The information processing apparatus 40 may not include the input part 407 and the display 408.

### <Configuration>

Image Forming Apparatus 10

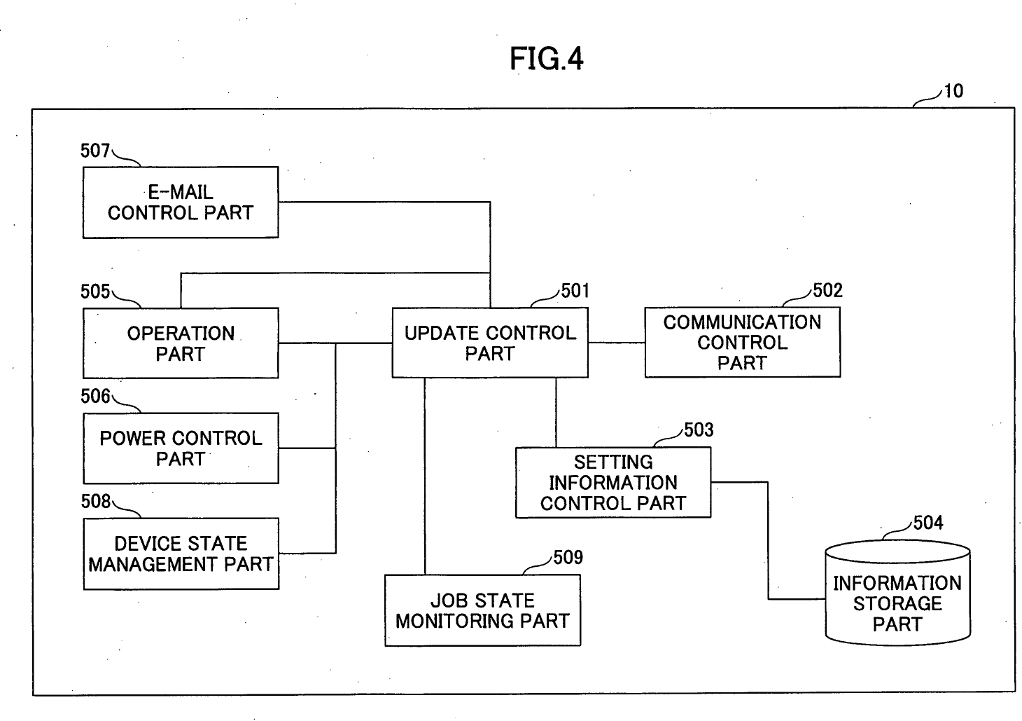

FIG. 4 is a block diagram illustrating an example of a configuration of the image forming apparatus 10 in the embodiment. As illustrated in FIG. 4, the image forming apparatus 10 includes an update control part 501, a communication control part 502, a setting information control part 503, an information storage part 504, an operation part 505, a power control part 506, an e-mail (electronic mail) control part 507, a device state management part 508, and a job state monitoring part 509.

The operation part 505 may be realized by the operation panel 102. The information storage part 504 may be realized by the HDD 133. Other parts 501, 502, 503, 506, 507, and 508 may be realized by processes executed by the CPU 111 and may be implemented as modules.

The update control part 501 detects a predetermined trigger, and controls setting and updating of the preference information. The predetermined trigger may be an operation by an administrator, a power on (activation), an update notice periodically received from a server, an abnormality occurrence of a device, and the like.

The update control part 501 stores a setting value indicating whether a non-processed job is prioritized or an update of the preference information is prioritized. The setting value is set by the operation part 505.

The update control part 501 determines an update timing of the preference information acquired from the information processing apparatus 40 based on the setting value. Details of the update timing will be described later.

The communication control part 502 controls communication with an external device connected to the network 2. The communication control part 502 may send an acquisition request of the preference information in response to an instruction received from the update control part 501, and receive the preference information from the information processing apparatus 40. The communication control part 502 may send a device ID and authentication information (user account, password) for an authentication before sending the acquisition request of the preference information. The setting information control part 503 controls setting the preference information for a device. The information storage part 504 stores the preference information to set to the device and the like.

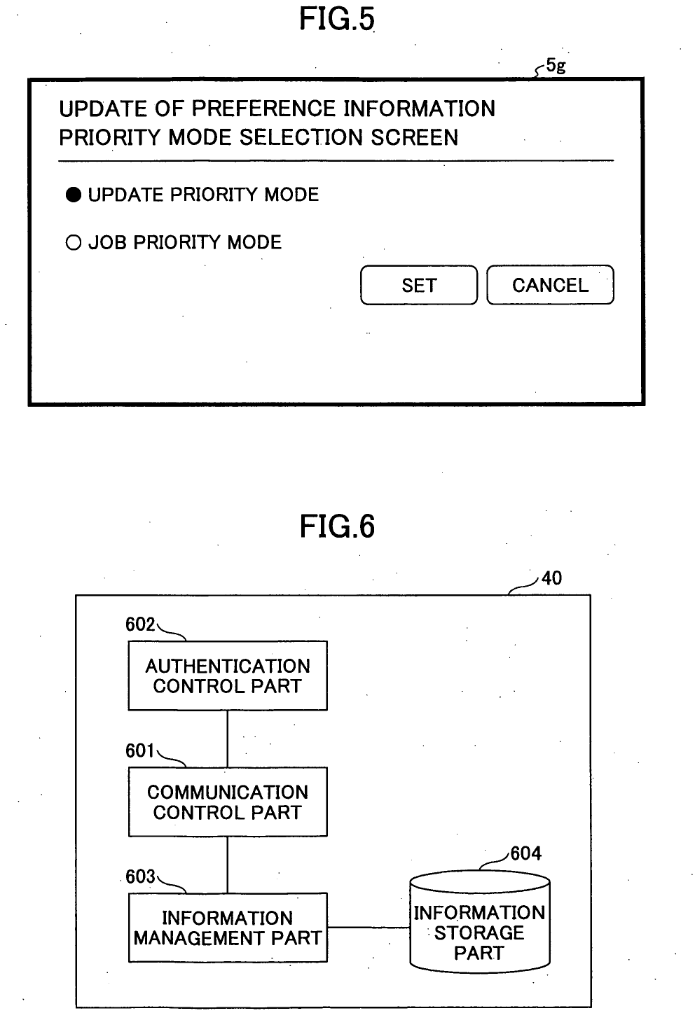

The operation part 505 accepts an operation from a user and conducts a screen display for the user. When an administrator indicates an update of the preference information, the operation part 505 may send an update request notice. The operation part 505 displays a priority mode selection screen (FIG. 5) for selecting whether to prioritize the job or to prioritize the update of the preference information.

FIG. 5 is a diagram illustrating an example of the priority mode selection screen. In a priority mode selection screen 5g illustrated in FIG. 5, the administrator selects one of an update priority mode and a job priority mode. The operation part 505 detects the mode selected by the administrator and sends a notice indicating the mode to the update control part 501.

Referring back to FIG. 4, the power control part 506 controls ON and OFF of power. The e-mail control part 507 controls an e-mail transmission for the user. The e-mail control part 507 may send an e-mail describing a setting failure and a failure reason of the preference information.

The device state management part 508 manages a state of the device and sends a notice indicating abnormal state and the like to another component part. The job state monitoring part 509 monitors whether the job exists in the image forming apparatus 10, and sends a notice indicating its job state to another device when the job exists. The job state may indicate an execution state, a non-processed state, a temporary stop state, or the like.

By implementing the above described configuration, the image forming apparatus 10 sends the acquisition request of the preference information to the information processing apparatus 40 in response to a predetermined trigger. Thus, it is possible to set and update the preference information acquired from the information processing apparatus 40. Also, in the image forming apparatus 10, for a case in which the preference information is acquired and there is a non-processed job, it is determined beforehand whether to update the preference information before the job or to update the preference information after processing the non-processed job. Accordingly, it is possible to prevent a process of a job with an unexpected setting value. Each of configurations of image forming apparatuses 20, and 30 is the same as the configuration of the image forming apparatus 10, and the explanation thereof will be omitted.
Information Processing Apparatus 40

FIG. 6 is a block diagram illustrating an example of a configuration of the information processing apparatus 40. In FIG. 6, the information processing apparatus 40 includes a communication control part 601, an authentication control part 602, an information management part 603, and an information storage part 604.

The communication control part 601 may be realized by the network I/F part 406. The information storage part 604 may be realized by the auxiliary storage part 403. In another configuration, the information storage part 604 may be realized by the control part 401 and the main storage part 402 used as a working memory. The parts 601, 602, and 603 other than the information storage part 604 may be implemented as modules.

The communication control part 601 controls a communication with the external device connected to the network 2. The communication control part 601 may receive the acquisition request of the preference information and the authentication information from the image forming apparatus 10. Also, the communication control part 601 sends the preference information to the image forming apparatus 10.

The authentication control part 602 conducts an authentication process by using the authentication information when the communication control part 601 acquires the authentication information. For example, the authentication process may check an acquired device ID, and check a user account and the password. The communication control part 601 sends an authentication result to the image forming apparatus 10.

The information management part 603 reads out the preference information from the information storage part 604 when the communication control part 601 receives the acquisition request of the preference information.

The information storage part 604 stores the preference information which is set in common with multiple image forming apparatuses 10, 20, 30, and the like connected to the network 2.

FIG. 7A and FIG. 7B are diagrams illustrating an example of the preference information. Preference information 6 illustrated in FIG. 7A and FIG. 7B includes all setting items and may be managed by a data file. Also, in FIG. 7A and FIG. 7B, setting examples are illustrated for each of the setting items. Setting values as illustrated by the setting examples are set to each of the image forming apparatuses 10, 20, 30, and the like.

When the preference information 6 is updated, the information processing apparatus 40 sends an update notice through the communication control part 601 to each of the multiple image forming apparatuses 10, 20, 30, and the like connected to the network 2.

In a case in which common preference information 6 is set to the multiple image forming apparatuses 10, 20, 30, and the like, time for downloading the preference information 6 may be different for each of the multiple image forming apparatuses 10, 20, 30, and the like. By implementing the above described configuration in the information processing apparatus 40, it is possible to prevent imposing a considerable load to a communication path. It is possible for the administrator to easily maintain the preference information 6.

<Operation>

Next, an operation of the information setting system 1000 in the embodiment will be described. First, a setting process of the preference information 6 will be described.

(Setting Process of Preference Information)

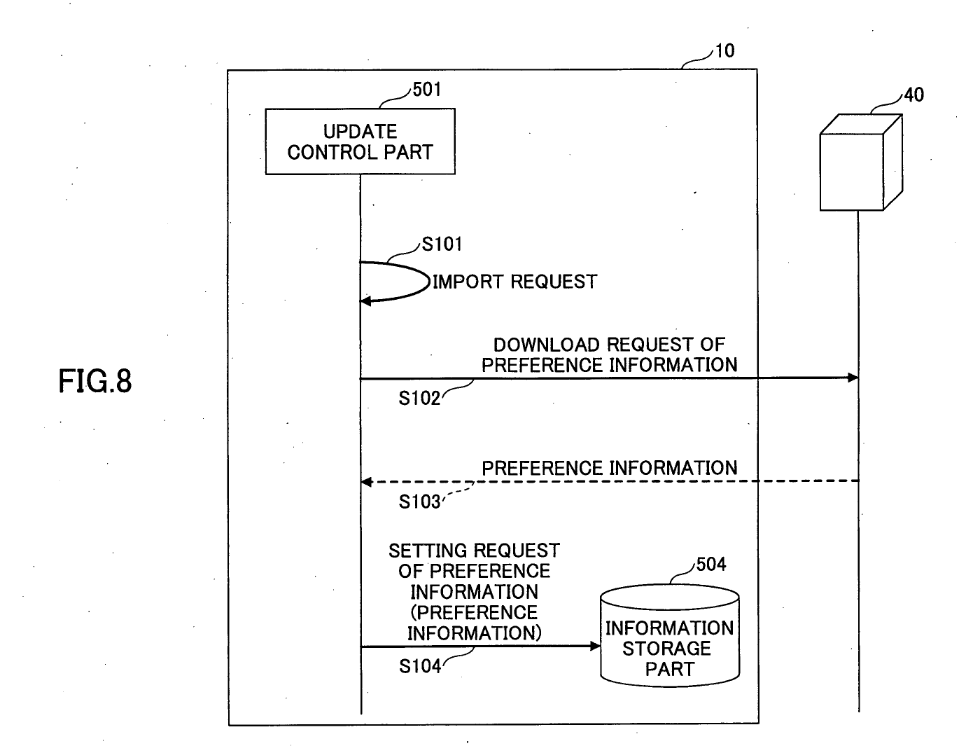

FIG. 8 is a sequence diagram illustrating an example of the setting process of the preference information 6 in the embodiment. In step S101 in FIG. 8, the update control part 501 detects an import request of the preference information 6 based on the predetermined trigger.

In step S102, the update control part 501 sends a download request of the preference information 6 to the information processing apparatus 40 through the communication control part 502 when it is determined there is the import request.

In step S103, when receiving the download request of the preference information 6 from the image forming apparatus 10, the information processing apparatus 40 reads out and sends the preference information 6 to the multiple image forming apparatuses 10, 20, 30, and the like.

In step S104, the update control part 501 sends the setting request of the downloaded preference information 6 to the setting information control part 503. The setting information control part 503 sets and updates the setting information (preference information 6) stored in the information storage part 504 to be the downloaded preference information 6.

Each of the multiple image forming apparatuses 10, 20, 30, and the like connected to the network 2 executes the setting process illustrated in FIG. 8. Accordingly, it is possible to avoid imposing a load on the communication path all at once and to properly set the preference information 6 in common for the multiple image forming apparatuses 10, 20, 30, and the like.

(Setting Process of preference information 6 Based On Mode)

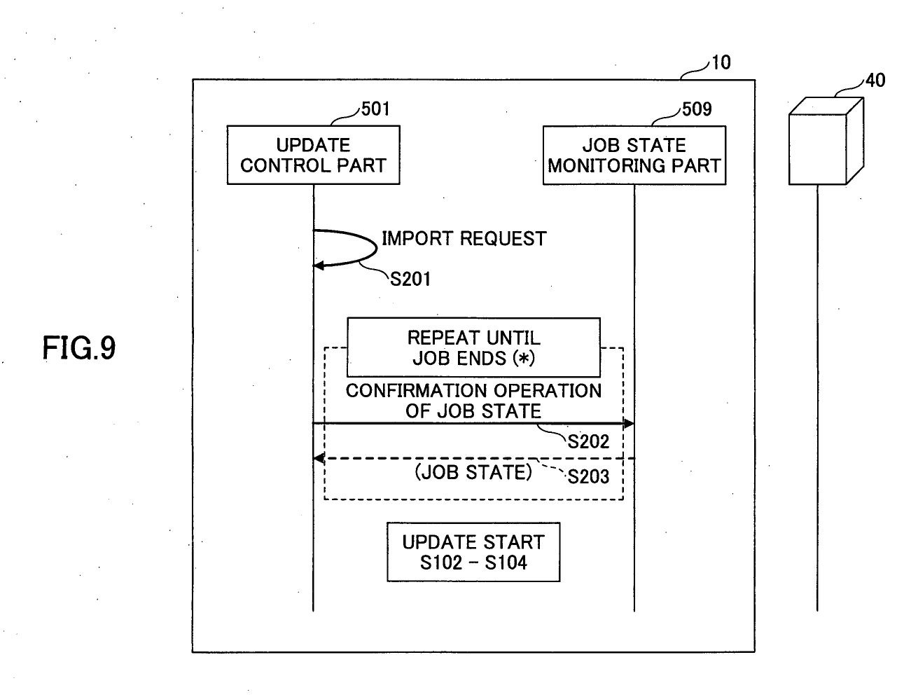

FIG. 9 is a sequence diagram illustrating an example of the setting process of the preference information 6 for the job priority mode in the embodiment. In FIG. 9, it is assumed that the job priority mode is set to the image forming apparatus 10. In step S201 illustrated in FIG. 9, the update control part 501 detects the import request based on the predetermined trigger.

In step S202, the update control part 501 outputs the acquisition request of the job state to the job state monitoring part 509 to confirm the job state in the image forming apparatus 10.

In step S203, the job state monitoring part 509 outputs information indicating a state of the job in the image forming apparatus 10 to the update control part 501.

Since the job priority mode is set, the update control part 501 repeats the steps S202 and S203 until all jobs end. When all jobs end, the update control part 501 starts an update process. The update process corresponds to the steps S102 through S104 illustrated in FIG. 8.

In the above described setting process for the job priority mode, the preference information 6 is updated when all jobs end in the image forming apparatus 10. Advantageously, it is possible to use the image forming apparatus 10 without any problem. The job in the image forming apparatus 10 may be a job in a state of waiting an execution, a job in the execution, or a job in a temporary stop. Also, the “job” represents processes concerning an image formation in the image forming apparatus 10 such as a printing process, a distributing process, a converting process, and the like of the image data.

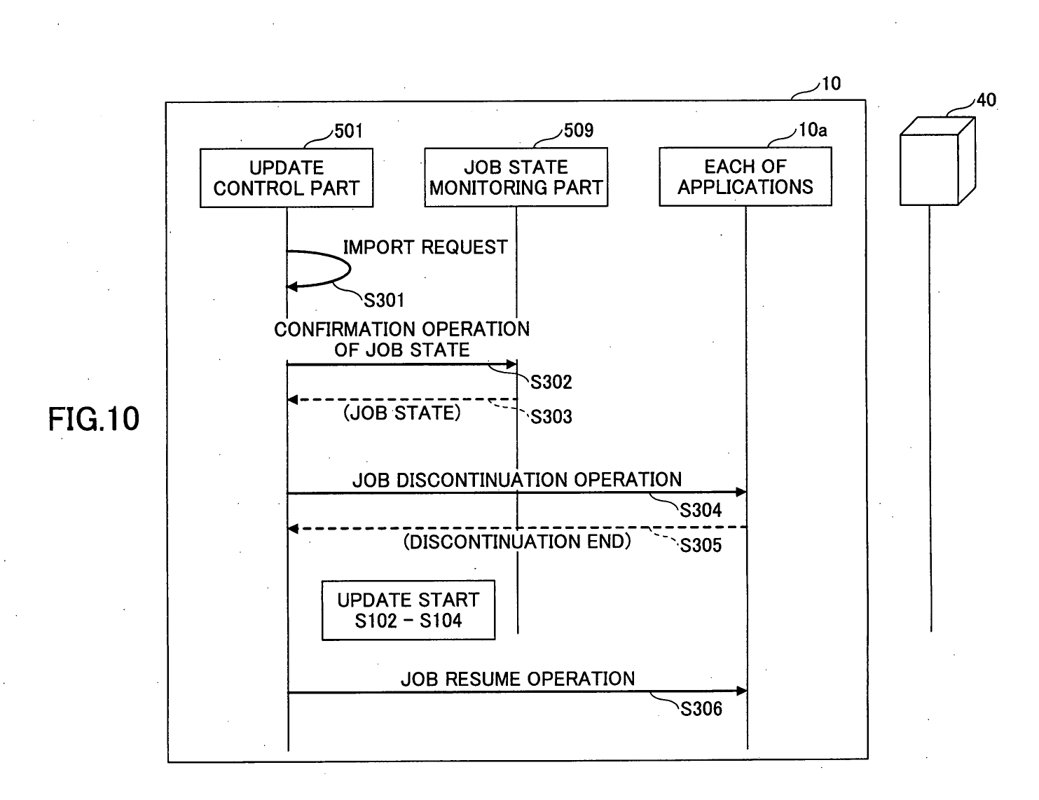

FIG. 10 is a sequence diagram illustrating an example of the setting process of the preference information 6 for the update priority mode in the embodiment. In the image forming apparatus 10 illustrated in FIG. 10, it is assumed that the update priority mode is set to the image forming apparatus 10. In step S301 illustrated in FIG. 10, the update control part 501 detects the import request based on the predetermined trigger.

In step S302, the update control part 501 outputs the acquisition request of the job state to the job state monitoring part 509 to confirm the job state in the image forming apparatus 10.

In step S303, the job state monitoring part 509 outputs the information indicating the state of the job in the image forming apparatus 10 to the update control part 501.

Since the update priority mode is set, after the job in a current execution ends, the update control part 501 executes the following process to perform the update process of the preference information 6.

In step S304, the update control part 501 controls each of applications 10a including the non-processed job to discontinue the job. In this case, a discontinuation of the job may correspond to the temporary stop of the job.

In step S305, when the discontinuation of the job ends, each of the applications 10a sends a discontinuation end to the update control part 501. Accordingly, it is possible to prevent an execution of a first waiting job in a process order during the update of the preference information 6 after the job in the execution ends.

Next, when the update control part 501 acquires a discontinuation end notice from each of the applications 10a, the update control part 501 starts the update process of the preference information 6. The update process corresponds to the steps S102 through S104 illustrated in FIG. 8.

In step S306, when the update process ends, the update control part 501 initiates a job resume operation to each of the applications 10a. The update control part 501 controls each of the applications 10a to return from the temporary stop state to the waiting state.

As described above, since the setting process of the preference information 6 is promptly executed, it is possible to execute the job by the setting value of the updated preference information 6.

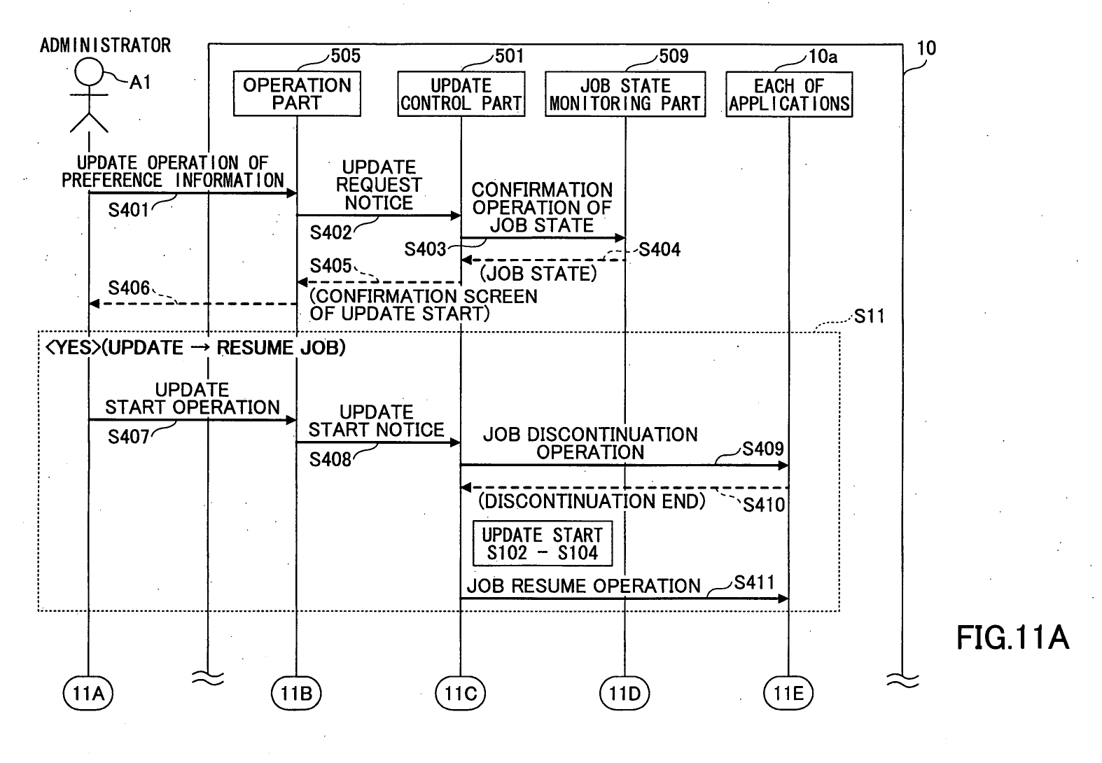

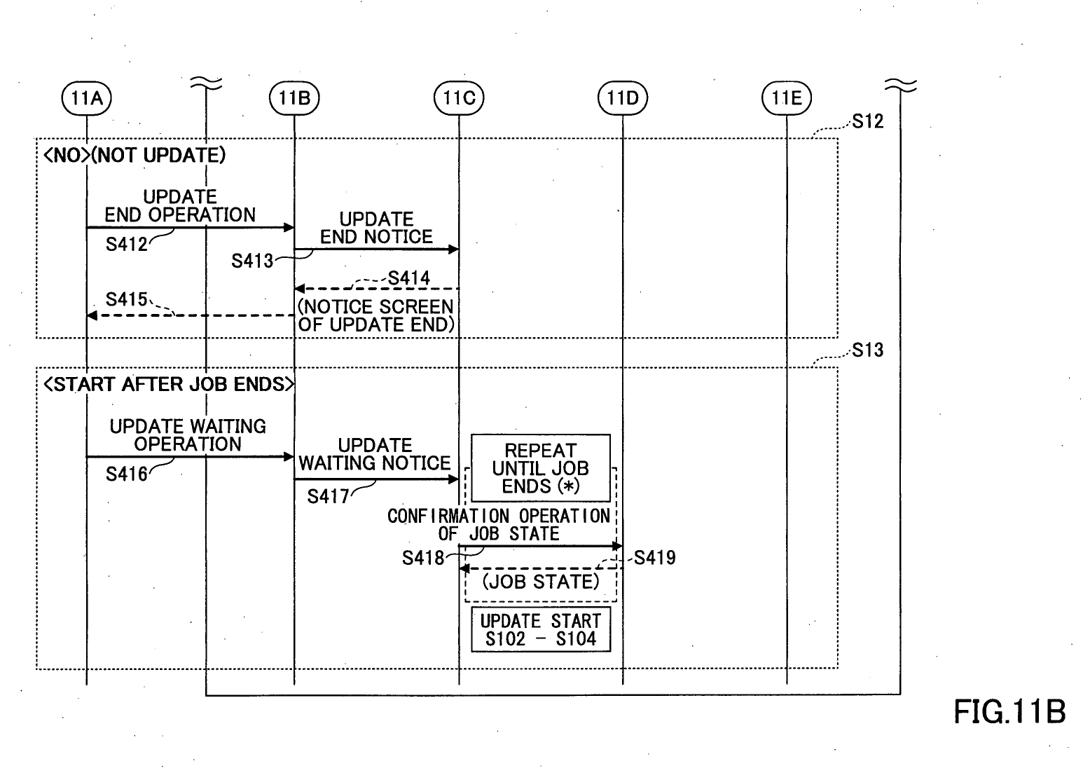

FIG. 11A and FIG. 11B are sequence diagrams illustrating a first example of the setting process of the preference information 6 with an update confirmation in the embodiment. In FIG. 11A and FIG. 11B, in a case in which an administrator A1 operates the operation part 505 to update the preference information 6, if there is a waiting job in the image forming apparatus 10, the setting process allows the administrator A1 to select to update, not to update, or to update after the job ends.

In step S401 in FIG. 11A, the administrator 1 performs an operation for updating the preference information 6. In step S402, when the operation part 505 detects the operation for updating the preference information 6, the operation part 505 sends the update request notice to the update control part 501.

In step S403, the update control part 501 outputs the acquisition request of the job state to the job state monitoring part 509.

In step S404, the job state monitoring part 509 outputs the information indicating the state of the job in the image forming apparatus 10 to the update control part 501.

In step S405, the update control part 501 sends a notice for displaying a confirmation screen of the update start to the operation part 505.

In step S406, the operation part 505 displays the confirmation screen of the update start for the administrator A1 to select a process to be executed afterwards.

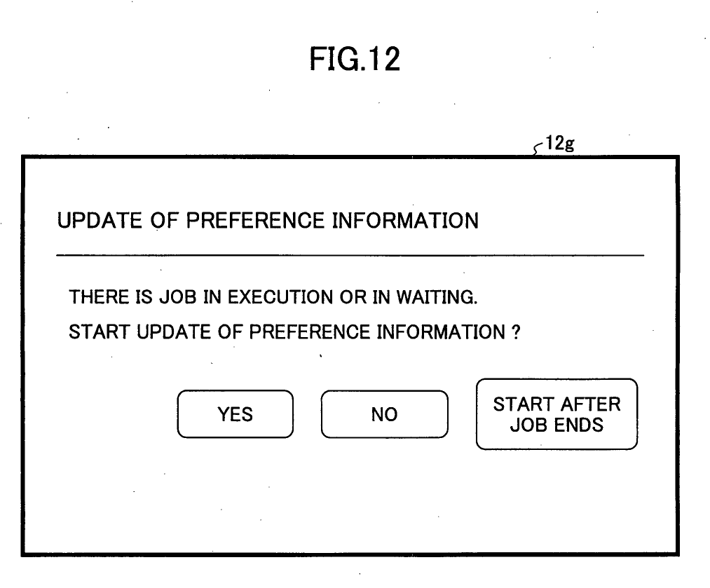

FIG. 12 is a diagram illustrating a first example of the confirmation screen. In FIG. 12, in a case in which the update request is made, if there is the job in the image forming apparatus 10, a confirmation screen 12g is displayed for the administrator A1 to select to update the preference information 6 after the job in the execution is processed (a “YES” button in FIG. 12), to cancel the update of the preference information 6 (a “NO” button in FIG. 12), or to update the preference information 6 after all jobs end (a “START AFTER JOB ENDS” button in FIG. 12).

When the administrator A1 presses the “YES” button illustrated in FIG. 12, a process of step S11 is performed. When the administrator A1 presses the “NO” button illustrated in FIG. 12, a process of step S12 is performed. When the administrator A1 presses the “START AFTER JOB ENDS” button illustrated in FIG. 12, a process of step S13 is performed.
a case in which the “YES” button is pressed

In the step S11, the steps S407 through S411 are conducted. In the step S407, the administrator A1 presses the “YES” button illustrated in FIG. 12.

In the step S408, when the operation part 505 detects pressing of the “YES” button, the operation part 505 determines that the update starts, and sends the update start notice to the update control part 501.

Processes in the steps S409 through S411 are performed similar to processes in the steps S304 through S306 illustrated in FIG. 10, and the explanation thereof will not be described.
a case in which the “NO” button is pressed

In the process of the step S12 in FIG. 11B, processes in steps S412 through S415 are performed. In the step S412, the administrator A1 presses the “NO” button illustrated in FIG. 12.

In step S413, when the operation part 505 detects pressing of the “NO” button, the operation part 505 sends an update end notice to the update control part 501.

In the step S414, when the update end notice is received from the operation part 505, the update control part 501 sends a display request of an update end notice screen to the operation part 505.

In the step S415, the operation part 505 displays the update end notice screen to notify an update end to the administrator A1.

A Case in Which the “START AFTER JOB ENDS” Button is Pressed

In the step S13, processes in steps S416 through S419, and the update process are performed. In the step S416, the administrator A1 presses the “START AFTER JOB ENDS” button illustrated in FIG. 12.

In the step S417, when the operation part 505 detects pressing of the “START AFTER JOB ENDS” button, the operation part 505 determines that the state indicates an update waiting and sends an update waiting notice to the update control part 501.

The steps S418 and S419, and the update process correspond to the steps S202 and S203 illustrated in FIG. 9, and the steps S102 through S104 illustrated in FIG. 8, and the explanation thereof will be omitted.

As described above, in a case in which the update of the preference information 6 is requested, if there is the job in the image forming apparatus 10, it is possible to allow the administrator A1 to select the timing for the update process for each update operation initiated by the administrator A1.

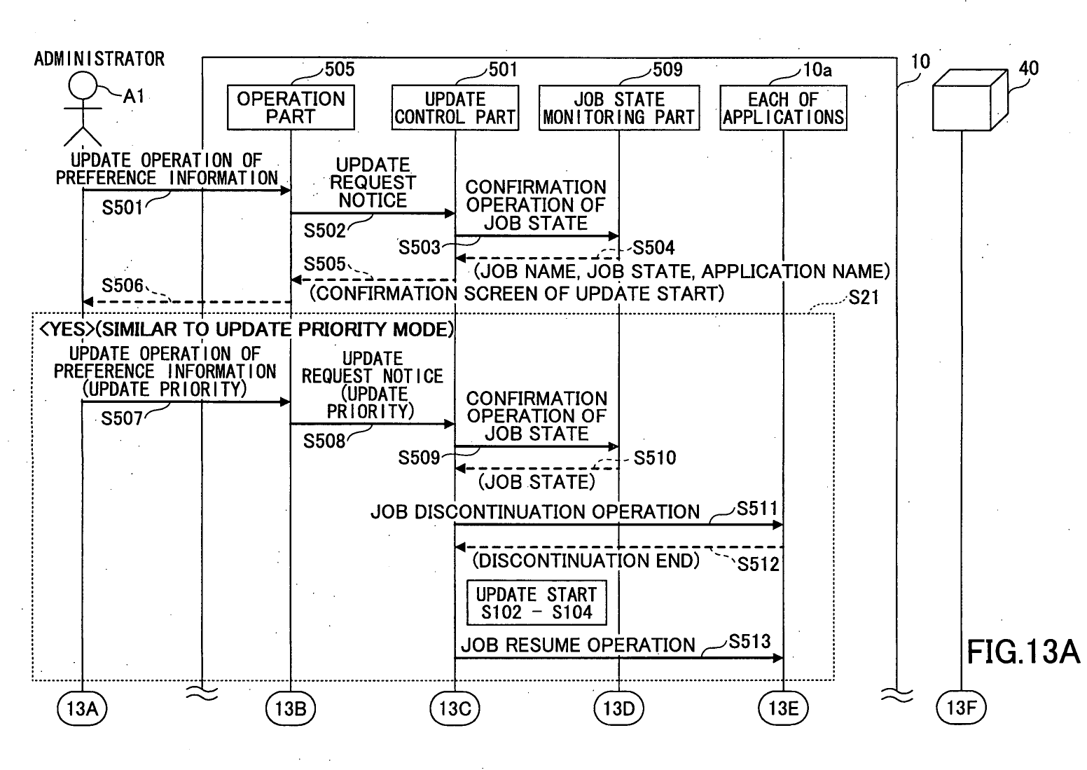

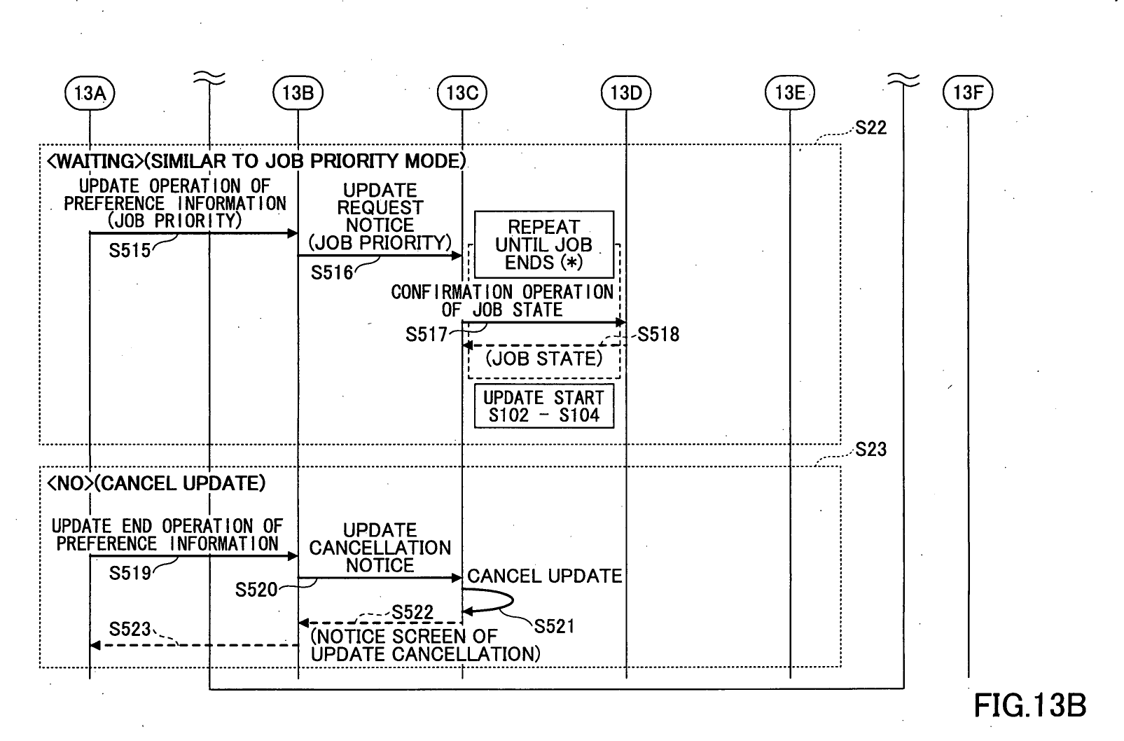

FIG. 13A and FIG. 13B are sequence diagrams illustrating a second example of the setting process of the preference information 6 with the update confirmation in the embodiment. In FIG. 13A and FIG. 13B, in a case in which the administrator A1 operates the operation part 505 to update the preference information 6, when there is the job in the waiting state in the image forming apparatus 10, contents of the job are displayed to allow the administrator A1 to select to update, not to update, or to wait for the update.

In step S501, the administrator A1 operates to update the preference information 6. In step S502, the operation part 505 detects the operation for updating the preference information 6, and sends the update request notice to the update control part 501.

In step S503, the update control part 501 outputs the acquisition request of the job state and the like to the job state monitoring part 509.

In step S504, the job state monitoring part 509 outputs information indicating the job state, job name, application name, and the like for each of jobs in the image forming apparatus 10, to the update control part 501.

In step S505, the update control part 501 sends a notice for displaying the confirmation screen of the update start to the operation part 505.

In step S506, the operation part 505 displays the confirmation screen of the update start to allow the administrator A1 to select a process to be executed after the setting process.

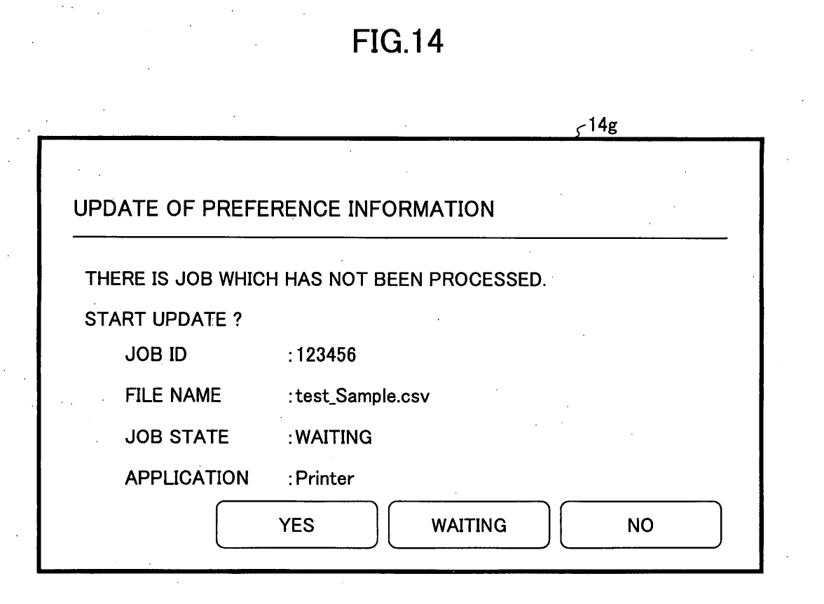

FIG. 14 is a diagram illustrating a second example of the confirmation screen. A confirmation screen 14g illustrated in FIG. 14 displays contents of the waiting job. The contents may indicate a job ID, a file name, a job state, and the application to be executed.

As described above, in a case in which the update request is made, if there is the job in the image forming apparatus 10, the contents of the waiting job are displayed in the confirmation screen 12g for the administrator A1 to select to update the preference information 6 before the non-processed job is executed (a “YES” button in FIG. 14), to cancel the update of the preference information 6 (a “NO” button in FIG. 14), or to update the preference information 6 after all jobs end (a “WAITING” button in FIG. 14)

In the confirmation screen 14g illustrated in FIG. 14, when the “YES” button is pressed, a process in step 521 is executed. When the “NO” button is pressed, a process in step S23 is executed. When the “WAITING” button is pressed, a process in step S22 is executed.
a case in which the “YES” button is pressed

In step S21, processes in steps S507 through S513 are executed. In step S507, the administrator A1 presses the “YES” button illustrated in FIG. 14. Then, the update operation of the preference information 6 (update priority) is made to the operation part 505.

In step S508, when the operation part 505 detects pressing of the “YES” button, the operation part 505 determines that the update starts, and sends the update request notice of the update priority mode to the update control part 501.

In step S509, the update control part 501 sends the acquisition request of the job state to the job state monitoring part 509.

In step S510, the job state monitoring part 509 outputs information indicating the job state in the image forming apparatus 10 to the update control part 501.

Processes in S511 through S513 are performed similar to processes in the steps S304 through S306 illustrated in FIG. 10, and the explanation thereof will be omitted.
a case in which the “WAITING” button is pressed

In step S22, processes in steps S515 through S518, and the update process are executed. In the step S515, the administrator A1 presses the “WAITING” button illustrated in FIG. 14. Then, an update operation of the preference information 6 (job priority) is made to the operation part 505.

In the step S516, when the operation part 505 detects pressing of the “WAITING” button, the operation part 505 determines that an update request of the job priority mode is made, and sends the update request notice of the job priority mode to the update control part 501.

Processes in the steps 517 and S518 are performed similar to processes in the steps S304 through S306 illustrated in FIG. 10, and the explanation thereof will be omitted.
a case in which the “NO” button is pressed

In step S23, processes insteps S519 through S523 are executed. In the step S519, the administrator A1 presses the “NO” button illustrated in FIG. 14. Then, an update end operation of the preference information 6 is made to the operation part 505.

In the step S520, when the operation part 505 detects pressing of the “NO” button, the operation part 505 determines that an update cancellation is made, and sends an update cancellation notice to the update control part 501.

In the steps S521 and S522, when the update control part 501 receives the update cancellation notice from the operation part 505, the update control part 501 sends a display request of an update cancellation notice screen to the operation part 505.

In the step S523, the operation part 505 displays the update cancellation notice screen to report the update cancellation to the administrator A1.

As described above, in a case in which the update request of the preference information 6 is made, if there is the job in the image forming apparatus 10, by displaying contents of the job in waiting, it is possible to allow the administrator A1 to select a process to be executed next based on the contents of the job.

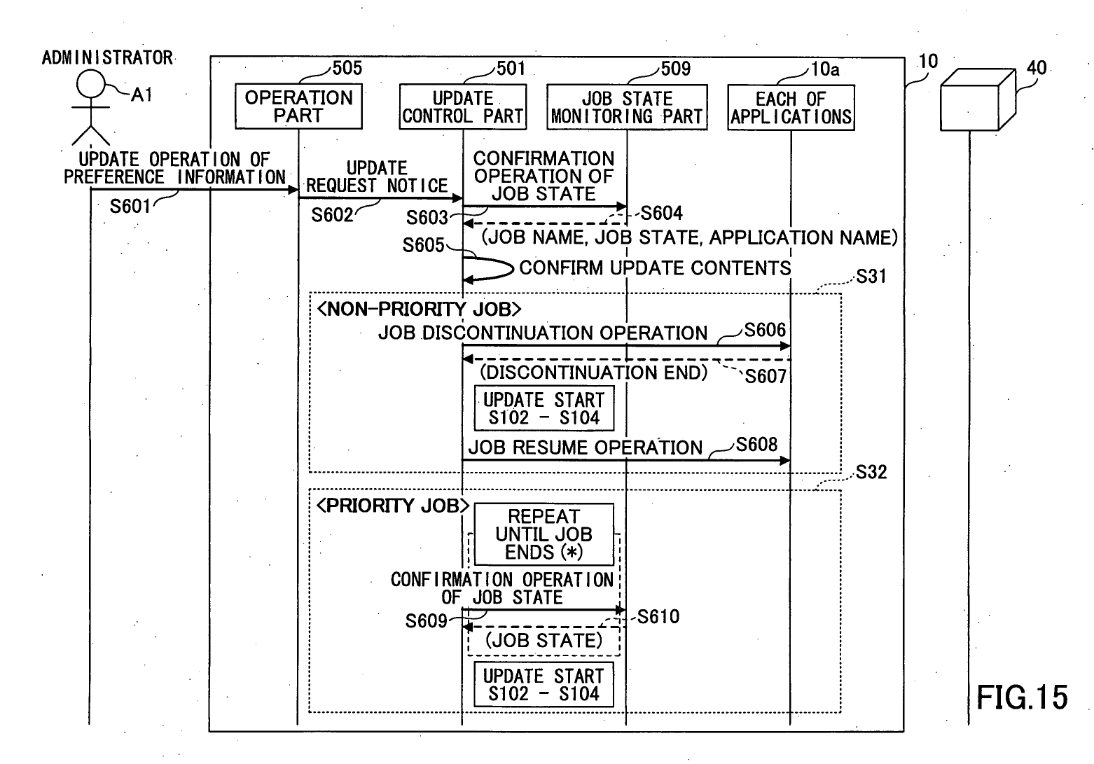

FIG. 15 is a sequence diagram illustrating an example of the setting process of preference information 6 performed for each of the jobs in the embodiment. In FIG. 15, the job priority mode and the update priority mode are set for each of the jobs. Setting information of the job priority mode and the update priority mode are stored in the information storage part 504, and the update control part 501 appropriately refers to the setting information. The job priority mode may be set for a copy job. The update priority mode may be set for an e-mail transmission job.

In step S601 illustrated in FIG. 15, the administrator A1 conducts an operation for updating the preference information 6. In step S602, when the operation part 505 detects the operation for updating the preference information 6, the operation part 505 sends the update request notice to the update control part 501.

In step S603, the update control part 501 outputs the acquisition request indicating the job state and the like to the job state monitoring part 509.

In step S604, the job state monitoring part 509 outputs the job state, the job name, the application name, and the like for each of jobs in the image forming apparatus 10, to the update control part 501.

In step S605, the update control part 501 confirms whether there is a job in waiting (a waiting job) for which the job priority mode is set. If the job priority mode is not set for the waiting job, the update control part 501 advances to step S31. If the job priority mode is set for the waiting job, the update control part 501 advances to step S32.
a case in which the job priority mode is not set for the waiting job (that is, the waiting job is not a priority job)

In step S31, processes in steps S606 through S608 (including the update process) are executed. Processes in steps S606 through S608 are similar to the processes in the steps S304 through S306 illustrated in FIG. 10, and the explanation thereof will be omitted. That is, the setting process in the update priority mode is executed.
a case in which the job priority mode is set for the waiting job (that is, the waiting job is the priority job)

In step S32, processes in steps S609 and S610 and the update process are executed. Processes in steps S609 and S610 and the update process are similar to the processes in the steps S202 and S203 illustrated in FIG. 9 and the processes in steps S102 through S104, and the explanation thereof will be omitted. That is, the setting process in the job priority mode is executed.

As described above, the job priority mode or the update priority mode is set for each of the jobs. It is possible to adaptively switch between types of update processes of the preference information 6 depending on the mode set for each of the jobs in waiting.

Also, in a case in which there are multiple jobs in waiting, the multiple jobs are scheduled to process the job for which the job priority mode is set, with a high priority. In this case, after an end of processing all jobs set in the job priority mode, the update process is executed. After the update process, jobs set in the update priority mode are sequentially processed.

(Setting Error Process)

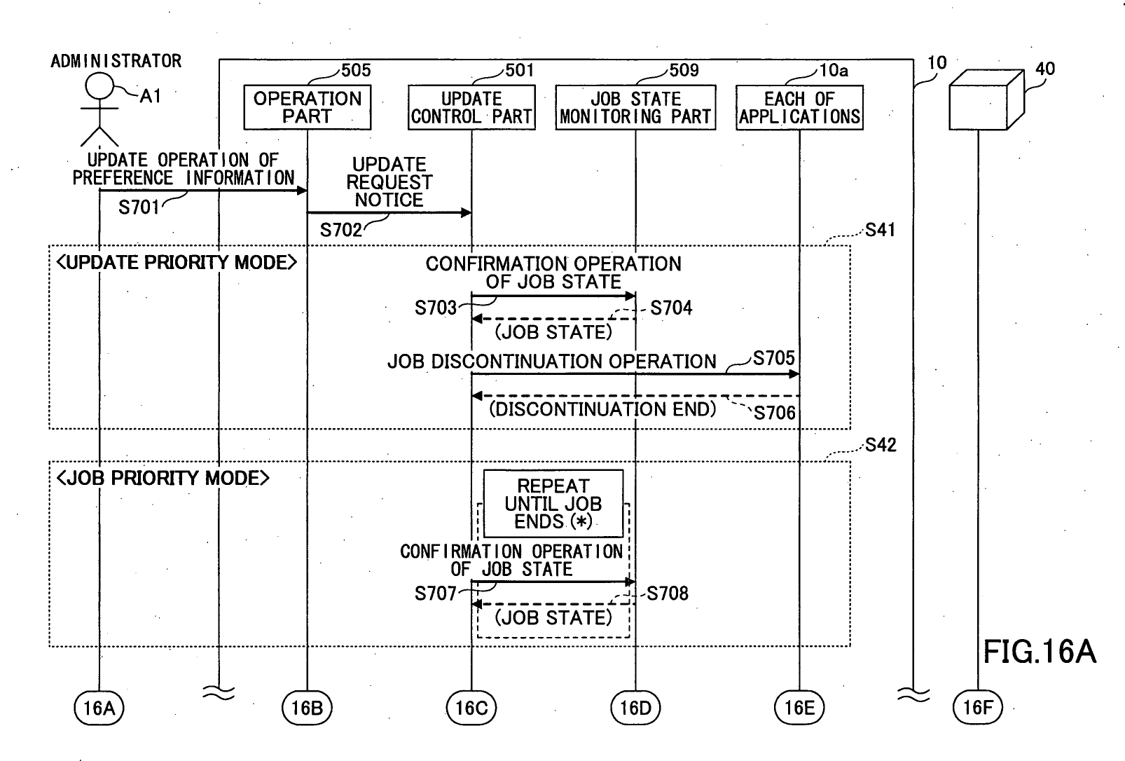

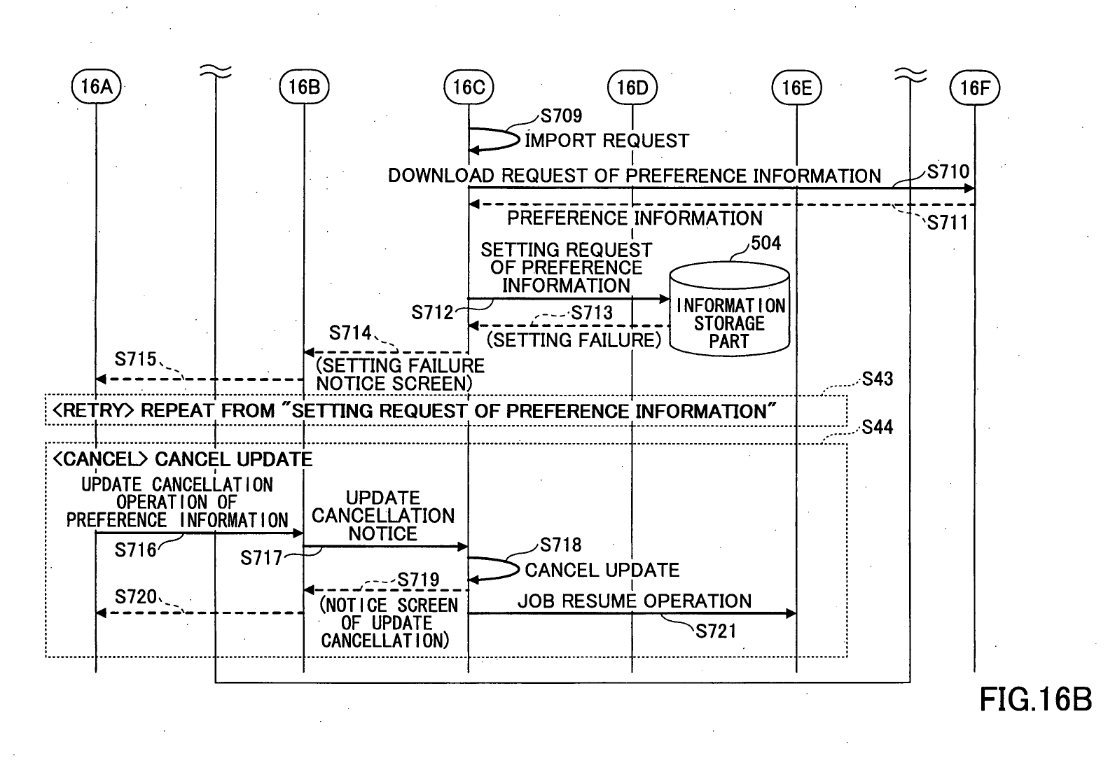

FIG. 16A and FIG. 16B are sequence diagrams illustrating a first example of a setting error process in the embodiment. A setting error is regarded as an error occurred when the preference information 6 is acquired and set. The setting error illustrated in FIG. 16A and FIG. 16B indicates a setting failure of the preference information 6.

In step S701 illustrated in FIG. 16A, the administrator A1 conducts the operation for updating the preference information 6. In step S702, when the operation part 505 detects the operation for updating the preference information 6, the operation part 505 sends the update request notice to the update control part 501. The update control part 501 determines whether the update priority mode is set or the job priority mode is set. When the update priority mode is set, the update control part 501 advances to step S41. When the job priority mode is set, the update control part 501 advances to step S42.

In an update priority mode process (step S41), processes insteps S703 through S706 are executed. Processes in the steps S703 through S706 are similar to the processes in the steps S302 through S305 illustrated in FIG. 10, and the explanation thereof will be omitted.

In a job priority mode process (step S42), processes in the steps S707 and S708 are executed. The processes in the steps S707 and S708 are similar to the processed in the steps S202 and S203 illustrated in FIG. 9, and the explanation thereof will be omitted.

In step S709 in FIG. 16B, the update control part 501 detects the import request. Processes in steps S710 through S712 are similar to the processes in the step S102 through S104 illustrated in FIG. 8, and the explanation thereof will be omitted.

In step S713, the update control part 501 detects the setting failure. The setting failure may indicate a failure to update the preference information 6 to the setting information stored in the information storage part 504. In a case in which an error occurs in the information storage part 504 or an abnormal value is set in the preference information 6, the setting failure is caused.

In step S714, the update control part 501 controls the operation part 505 to display a setting failure notice screen.

In step S715, when the operation part 505 receives an instruction to display the setting failure notice screen from the update control part 501, the operation part 505 displays the setting failure notice screen.

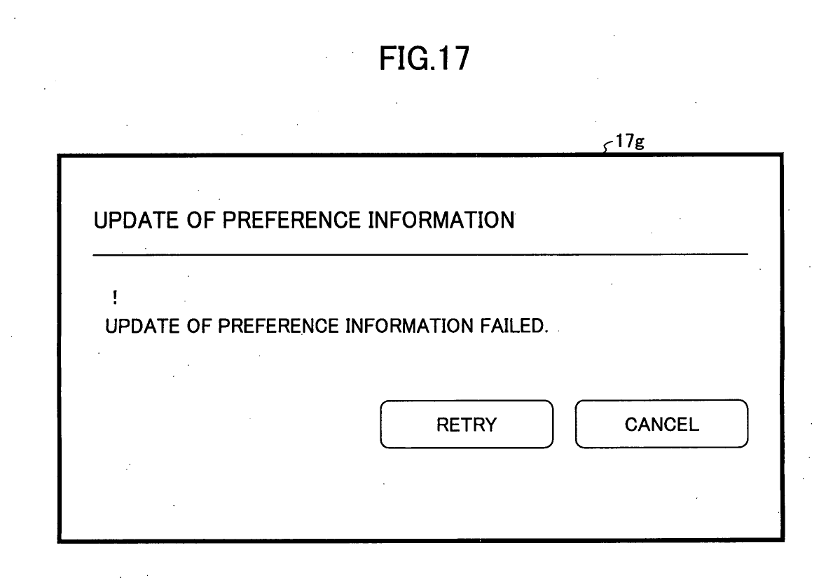

FIG. 17 is diagram illustrating a first example of the setting failure notice screen in the embodiment. A setting failure notice screen 17g as illustrated in FIG. 17 is displayed to report a setting failure. In the setting failure notice screen 17g in FIG. 17, a “RETRY” button and a “CANCEL” button are displayed.

When the “RETRY” button illustrated in FIG. 17 is pressed, a process in step S43 is executed. When the “CANCEL” button illustrated in FIG. 17 is pressed, a process in step S44 is executed.

The process instep S43 repeats from the process in step S712. In the process in step S44, processes in steps S716 through S720 are executed.

In step S716, the administrator A1 presses a “CANCEL” button illustrated in FIG. 17. In step S717, when the operation part 505 detects pressing of the “CANCEL” button, the operation part 505 determines that the update is cancelled, and sends the update cancellation notice to the update control part 501.

In steps S718 and S719, when the update cancellation notice is received from the operation part 505, the update control part 501 sends the display request of the update cancellation notice screen to the operation part 505.

In step S720, the operation part 505 displays the update cancellation notice screen to report the update cancellation to the administrator A1.

In step S721, in a case of the update priority mode, the update control part 501 performs the job resume operation for each of applications 10a.

As described above, in a case of the setting failure, it is possible for the image forming apparatus 10 to allow the administrator A1 to select a process to be executed next. The processes in the steps S41 and S42 may be performed after the process in the step S711.

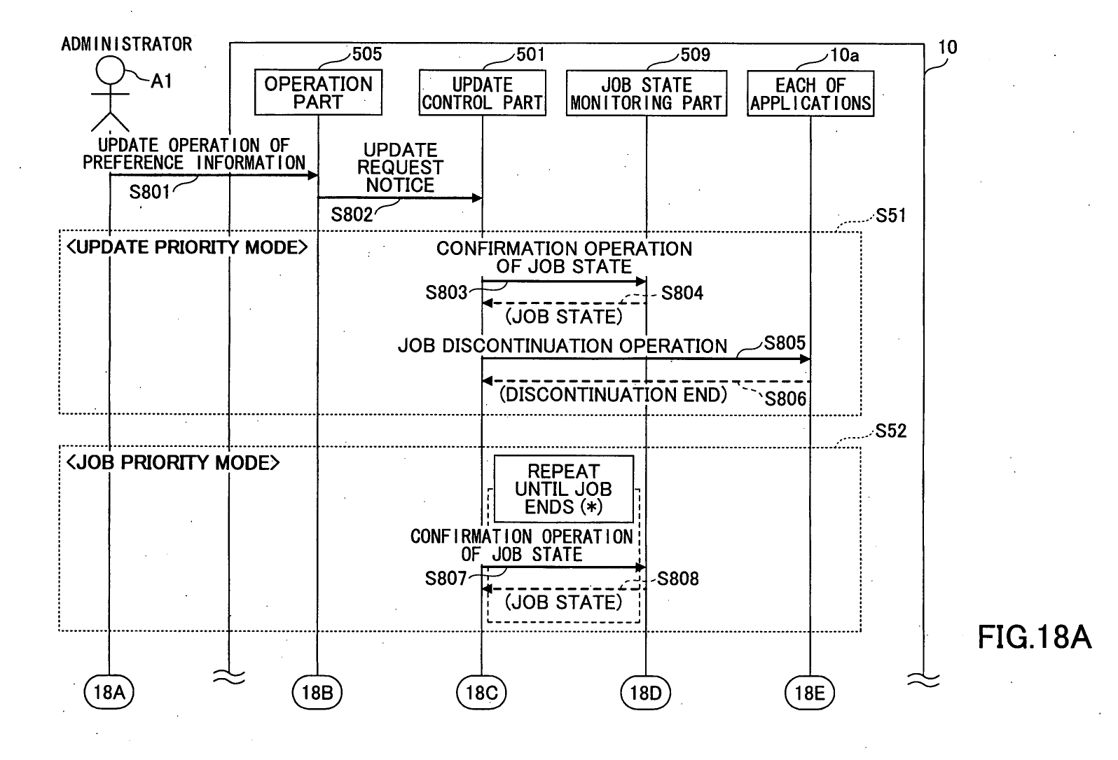

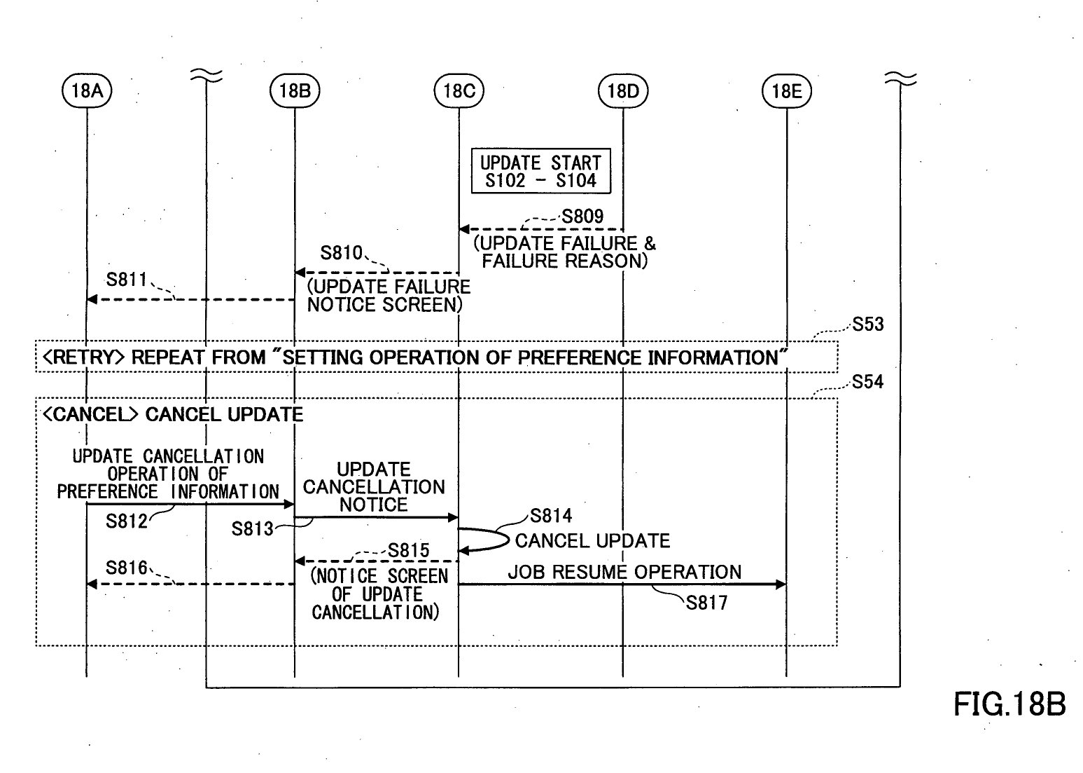

FIG. 18A and FIG. 18B are sequence diagrams illustrating a second example of the setting error process in the embodiment. The setting error illustrated in FIG. 18A and FIG. 18B indicates the update failure of the preference information 6. The update failure is regarded as a failure when the preference information 6 is downloaded from the information processing apparatus 40.

In step S801 illustrated in FIG. 18A, the administrator A1 conducts the operation for updating the preference information 6. In step S802, when the operation part 505 detects the operation for updating the preference information 6, the operation part 505 sends the update request notice to the update control part 501. The update control part 501 determines whether the update priority mode is set or the job priority mode is set. If the update priority mode is set, the setting error process advances to step S51. If the job priority mode is set, the setting error process advances to step S52.

An update priority mode process in the step S51 (steps S803 through S806) is similar to the update priority mode process in the step S41 illustrated in FIG. 16. A job priority mode process in the step S52 (steps S807 and S808) is similar to the job priority mode process in the step S42. The explanations thereof will be omitted. After the step S51 or the step S52, the update process starts.

The processes in the steps S102 through S104 illustrated in FIG. 8 are regularly performed as the update process in FIG. 18B. However, it is assumed that an error occurs in the process of the step S102 or the step S103 and the download of the preference information 6 failed.

In step S809, the update control part 501 receives a notice of the update failure and the reason thereof. The update failure and the reason thereof are not clearly described since a notice originator may be different depending on a failure factor. The failure factor may be a network fault, a write error when data are temporarily stored in a memory and the like.

In step S810, the update control part 501 controls the operation part 505 to display the update failure notice screen.

In step S811, when the operation part 505 receives an instruction for displaying the update failure notice screen from the update control part 501, the operation part 505 displays the update failure notice screen.

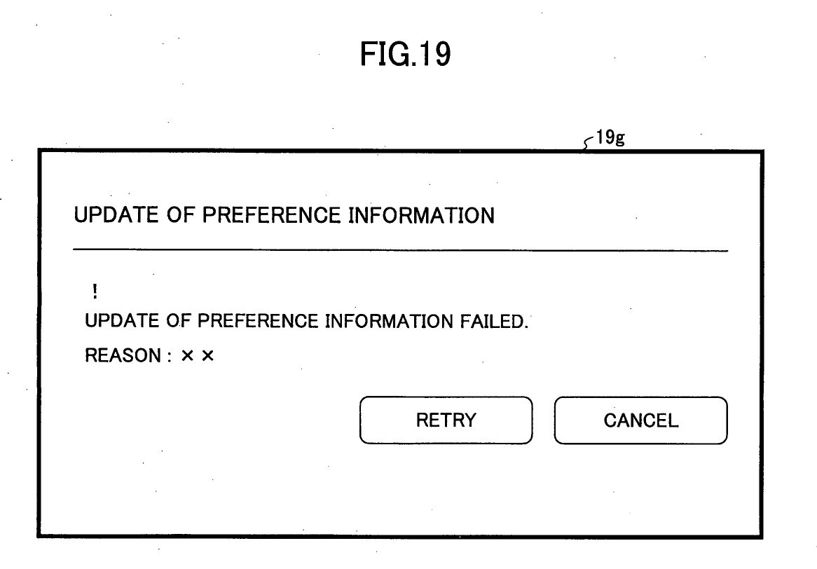

FIG. 19 is a diagram illustrating a second example of the failure notice screen in the embodiment. A failure notice screen 19g in FIG. 19 displays that the update failed. At the failure notice screen 19g illustrated in FIG. 19, a “RETRY” button and a “CANCEL” button are displayed.

When the “RETRY” button illustrated in FIG. 19 is pressed, a process in step S53 is executed. When the “CANCEL” button illustrated in FIG. 19 is pressed, a process in step S54 is executed.

In step S53, the setting error process repeats from the step S801. When the operation part 505 detects pressing of the “RETRY” button, it is determined that the update operation of the preference information 6 (step S801) is conducted, the setting error process conducts the step S802. Steps following the step S802 are conducted.

Process in step S54 (steps S812 through S816) is similar to the process in a step S44 illustrated in FIG. 16, and the explanation thereof will be omitted.

As described above, it is possible for the image forming apparatus 10 to allow the administrator A1 to select a process to be executed next when the update fails.

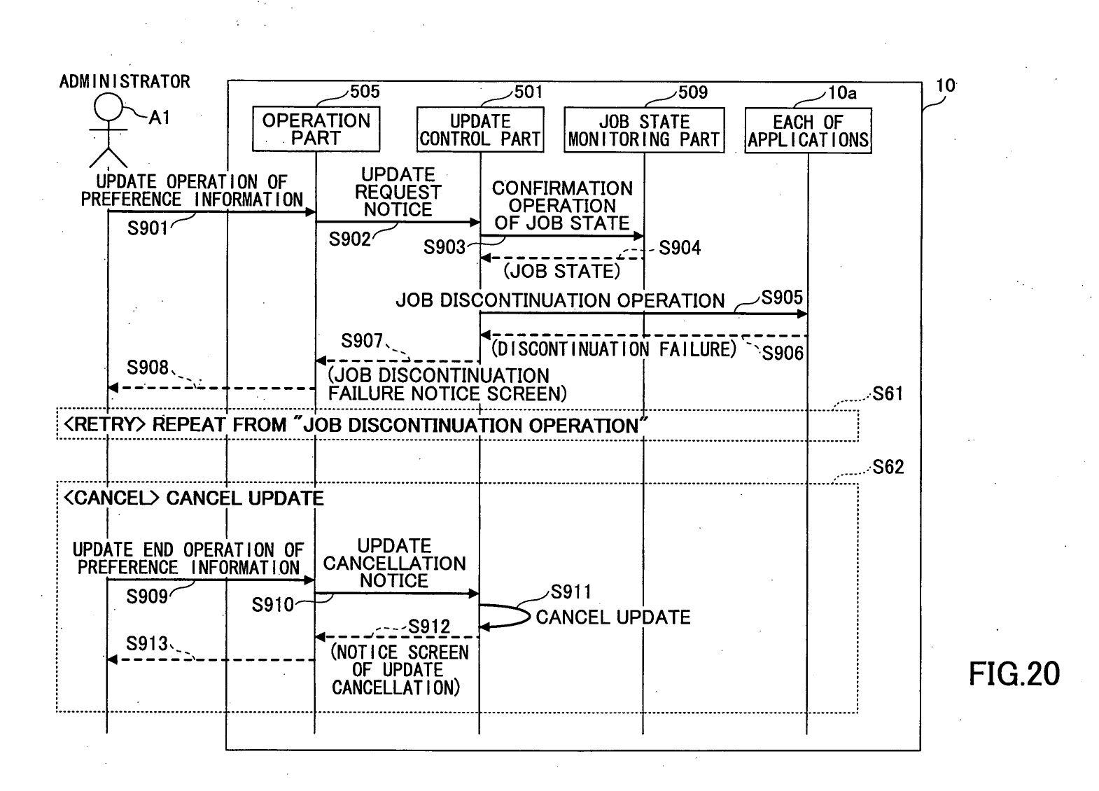

FIG. 20 is a sequence diagram illustrating a third example of the setting error process in the embodiment. The setting error illustrated in FIG. 20 may indicate a job discontinuation failure. The job discontinuation failure may be regard as a case in which one application 10a rejects a job discontinuation.

In step S901 illustrated in FIG. 20, the administrator A1 conducts the operation for updating the preference information 6. In step S902, when the operation part 505 detects the operation for updating the preference information 6, the operation part 505 sends the update request notice to the update control part 501. In this case, the update control part 501 reports that the update priority mode is set.

In step S903, the update control part 501 outputs the acquisition request of the job state to, the job state monitoring part 509 to confirm the job state in the image forming apparatus 10.

In step S904, the job state monitoring part 509 outputs the information indicating the state of the job in the image forming apparatus 10.

In step S905, the update control part 501 controls each of the applications 10a having non-processed jobs to discontinue the jobs.

In step S906, when one or more applications 10a having the non-processed jobs reject a job discontinuation, the update control part 501 receives a discontinuation failure notice.

The non-processed jobs, for which the one or more applications 10a reject the job discontinuation, may be jobs created by an operation made at the operation panel 102. A job for which the job discontinuation is rejected may regarded as a copy job entered at the operation panel 102 in which a sheet selection, a color selection, and the like may be performed.

The job occurred by an operation at the operation panel 102 may be prioritized since the administrator A1 is highly likely to be at a front of the image forming apparatus 10. Thus, the job may be executed before the discontinuation. Accordingly, a copy application having the copy job occurred by the operation at the operation panel 102 may reject the job discontinuation.

In step S907, the update control part 501 controls the operation part 505 to display the job discontinuation failure notice screen.

In step S908, when the operation panel 505 receives an instruction for displaying the job discontinuation failure notice screen from the update control part 501, the operation panel 505 displays the job discontinuation failure notice screen.

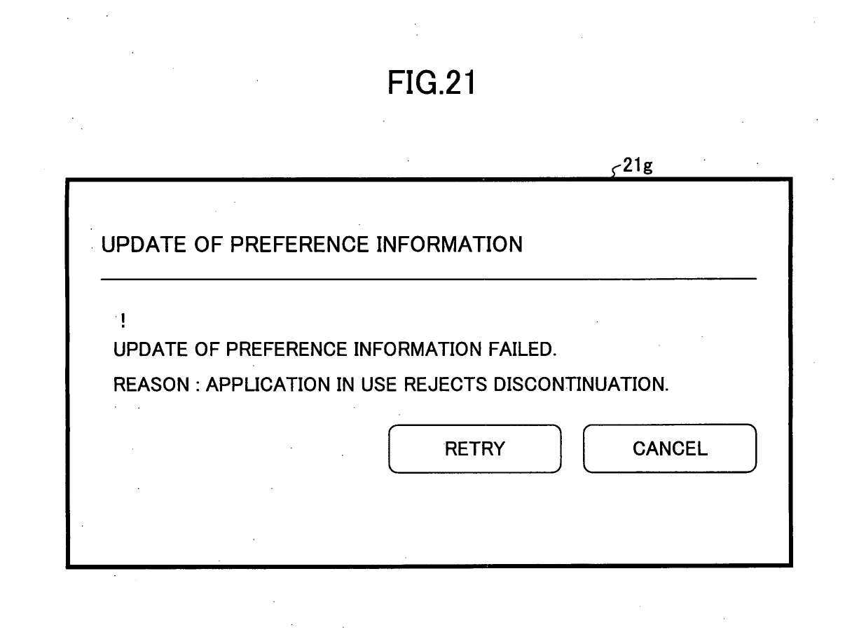

FIG. 21 is a diagram illustrating a third example of the failure notice screen in the embodiment. A failure notice screen 21g illustrated in FIG. 21 displays that the job discontinuation failed. In the failure notice screen 21g illustrated in FIG. 21, a “RETRY” button and a “CANCEL” button are displayed.

When the “RETRY” button illustrated in FIG. 21 is pressed, a process in step S61 is executed. When the “CANCEL” button illustrated in FIG. 21 is pressed, a process in step S62 is executed.

A process in step S61 repeats from the process in step S905. A process in step S62 (steps S909 through S913) is similar to the process in step S44 illustrated in FIG. 16, and the explanation thereof will be omitted.

As described above, it is possible for the image forming apparatus 10 to allow the a process to be executed next when the job discontinuation failure is rejected. When the job discontinuation failed, the update control part 501 may switch to the job priority mode. By this switch to the job priority mode, it is possible to execute a process related to the job for which the job discontinuation is rejected and to conduct the update process after the process related to the job. Also, a button for switching to the job priority mode may be provided in the failure notice screen 21g in illustrated in FIG. 21, and the administrator A1 may select the button to switch to the job priority mode. Moreover, after one or more jobs for which the job discontinuation is rejected are processed prior to the update, the preference information 6 may be updated. After the preference information 6 is updated, jobs being discontinued may be executed.

[Variation]

A program executed by the image forming apparatuses 10, 20, 30, and the like and a program executed by the information processing apparatus 40 may be recorded in a non-transitory computer-readable medium such as a CD-ROM (Compact Disk Read Only Memory), a FD (flexible disk), a CD-R (Compact Disc Recordable), a DVD (Digital Versatile Disk), and the like with a data file in an installable format or an executable format. The program may be provided by the non-transitory computer-readable medium.

Also, the program executed by the image forming apparatuses 10, 20, 30, and the like and the program executed by the information processing apparatus 40 may be stored in a computer connected to the network 2 such as the Internet or the like, and may be downloaded through the network 2. Moreover, the programs may be provided or distributed through the network 2 such as the Internet.

Furthermore, the program executed by the image forming apparatuses 10, 20, 30, and the like and the program executed by the information processing apparatus 40 may be stored in respective memories such as a ROM beforehand, and the respective memories maybe embedded in the image forming apparatuses 10, 20, 30, and the like and the information processing apparatus 40.

The program executed by the image forming apparatuses 10, 20, 30, and the like and the program executed by the information processing apparatus 40 may be formed in a module configuration to include the above described component parts. In the hardware configuration of each of the image forming apparatuses 10, 20, 30, and the like, one or more component parts 501, 502, 503, 506, 507, and 508 may be loaded into a memory when the CPU 111 (processor) reads out the program from the HDD 133 (auxiliary storage device) and executes the program. Thus, one or more component parts 501, 502, 503, 506, 507, and 508 may be formed in the memory. Similarly, one or more component parts 601, 602, and 603 of the information processing apparatus 40 may be formed in a memory.

According to the embodiment of the present invention, in a case in which the setting information of the device is set to the multiple image forming apparatuses 10, 20, 30, and the like, even if there is the job in the image forming apparatus 10 or the like which acquired the setting information, it is possible to properly set the setting information.

The present invention is not limited to the specifically disclosed embodiments, and variations and modifications may be made without departing from the scope of the present invention. One or more component elements may be omitted from the entirety of component elements illustrated in the embodiment.

The present application is based on Japanese Priority Application No. 2010-260121 filed Nov. 22, 2010, the entire contents of which are hereby incorporated by reference.

What is claimed is:

1. An image forming apparatus, comprising:
a storage part configured to store setting information for a function which the image forming apparatus operates based on the setting information;
a sending part configured to send an acquisition request of common setting information to an information processing apparatus including the common setting information in common with multiple of the image forming apparatuses connected through a network;
a receiving part configured to receive the common setting information from the information processing apparatus;
a monitoring part configured to monitor whether there is a job in the function; and
an update control part configured to control timing for setting the common setting information received by the receiving part to the setting information stored in the storage part based on whether a non-processed job is prioritized or an update is prioritized.

2. The image forming apparatus as claimed in claim 1, wherein the update control part is configured to allow to set either one of a job priority and an update priority for each of jobs of the function, and
controls to set the common setting information after the non-processed job is processed if the job priority is set for the non-processed job, and to set the common setting information before the non-processed job is processed if the update priority is set for the non-processed job, in a case in which the non-processed job is reported from the monitoring part.

3. The image forming apparatus as claimed in claim 1, wherein the update control part is configured to control setting the common setting information after non-processed jobs detected by the monitoring part end in a case in which the job priority is set beforehand, and to set the common setting information before the non-processed jobs detected by the monitoring part are processed in a case in which the update priority is set beforehand.

4. The image forming apparatus as claimed in claim 2, wherein the update control part is configured to discontinue the non-processed job until setting of the common setting information ends if the update priority is set.

5. The image forming apparatus as claimed in claim 4, wherein the update control part is configured to set the common setting information after the non-processed job is processed when the non-processed job is unable to be disconnected even in a case in which the update priority is set.

6. The image forming apparatus as claimed in claim 1, wherein the update control part further includes a reporting part configured to report a failure and a reason of the failure to an administrator of the image forming apparatus in a case of failure to acquire or set the common setting information.

7. An information setting system, comprising:
multiple image forming apparatuses each of which operates based on setting information for a function stored in a first storage part; and
an information processing apparatus connected to the multiple image forming apparatuses through a network,
wherein the information processing apparatus includes a second storage part configured to store common setting information in common with the multiple image forming apparatuses connected through the network; and
a communication part configured to send the common setting information to the multiple image forming apparatuses, when receiving an acquisition request of the common setting information from the multiple image forming apparatuses, and
each of the multiple image forming apparatuses includes a sending part configured to send an acquisition request of the common setting information to the information processing apparatus;
a receiving part configured to receive the common setting information from the information processing apparatus;
a monitoring part configured to monitor whether there is a job in the function; and
an update control part configured to control timing for setting the common setting information received from the receiving part to the setting information stored in the first storage part based on whether a non-processed job is prioritized or an update is prioritized.

8. The information setting system as claimed in claim 7, wherein the update control part is configured to allow to set either one of a job priority and an update priority for each of jobs of the function, and
controls to set the common setting information after the non-processed job is processed if the job priority is set for the non-processed job, and to set the common setting information before the non-processed job is processed if the update priority is set for the non-processed job, in a case in which the non-processed job is reported from the monitoring part.

9. The information setting system as claimed in claim 7, wherein the update control part is configured to control setting the common setting information after non-processed jobs detected by the monitoring part end in a case in which the job priority is set beforehand, and to set the common setting information before the non-processed jobs detected by the monitoring part are processed in a case in which the update priority is set beforehand.

10. The information setting system as claimed in claim 8, wherein the update control part is configured to discontinue the non-processed job until setting of the common setting information ends, if the update priority is set.

11. The information setting system as claimed in claim 10, wherein the update control part is configured to set the common setting information after the non-processed job is processed when the non-processed job is unable to be disconnected even in a case in which the update priority is set.

12. The information setting system as claimed in claim 7, wherein the update control part further includes a reporting part configured to report a failure and a reason of the failure to an administrator of the image forming apparatus in a case of failure to acquire or set the common setting information.

13. An information setting method performed in an image forming apparatus which operates based on setting information for a function stored in a storage part, said information setting method comprising:
a sending an acquisition request of common setting information to an information processing apparatus including the common setting information in common with multiple of the image forming apparatuses connected through a network;
a receiving the common setting information from the information processing apparatus;
a monitoring whether there is a job in the function; and
controlling timing for setting the common setting information received by the receiving part to the setting information stored in the storage part based on whether a non-processed job is prioritized or an update is prioritized.
